(19) United States
(12) Patent Application Publication
(10) Pub. No.: US 2016/0167179 A1
(43) Pub. Date: Jun. 16, 2016

(54) WELDED ASSEMBLY

(71) Applicant: Caterpillar Inc., Peoria, IL (US)

(72) Inventors: Huijun Wang, Peoria, IL (US); Kendall R. Powell, Peoria, IL (US)

(73) Assignee: Caterpillar Inc., Peoria, IL (US)

(21) Appl. No.: 14/570,111

(22) Filed: Dec. 15, 2014

(51) Int. Cl. B23K 37/04; B23K 20/00

(52) U.S. Cl. CPC B23K 37/04; B23K 20/00

(57) ABSTRACT

A welded assembly includes a first metal component, a second metal component, and a welded butt joint connecting the first metal component and the second metal component. The welded assembly further includes a retaining bracket, and a backing member held by the retaining bracket and positioned adjacent to the welded butt joint. The retaining bracket includes an attachment leg secured to the first metal component, and a support leg holding the backing member. The support leg urges the backing member toward the welded butt joint, and has a free distal end.

### TECHNICAL FIELD

This disclosure relates to welded assemblies, and more particularly, to welded assemblies that include backing members.

### BACKGROUND

Metal components can be joined together by a welding operation. In a welded butt joint, for example, two metal components are positioned in an abutting, or end-to-end, relationship, and molten weld material is put into the space between the metal components. The weld material fills the space between the metal components and adheres to both, and then cool. Thereby, the metal components are secured together.

Backing members are sometimes used to control the flow of molten weld material as a welded joint is formed. For example, U.S. Pat. No. 4,182,951 discloses a flexible “weld back up tape” that is placed over the junction of two plate members that are to be joined in a welded butt joint. The weld back up tape includes two edge regions that are coated with an adhesive. Those edge regions are each covered by a release liner, which is removed to expose the adhesive when the weld back up tape is to be stuck to a plate member. The weld back up tape also includes several back up blocks between the edge regions. In use, each edge region is stuck to one of the respective plate members, and the back up blocks are positioned beneath the space defined between the plate members. The back up blocks include a grooved recess, which is open below the lower surfaces of the plate members. Weld material is introduced into the space between the plate members, and travels below the plate members until it reaches the back up blocks, where it is stopped from flowing any further.

The weld back up tape of the '951 patent has disadvantages, however. First, the ability of the adhesive to retain the weld back up tape in position on the plate members can degrade as the adhesive is heated during a welding operation. If the back up blocks are not held in place, they will not block the flow of weld material. Second, each edge region must be adhered to a respective plate member in order to hold the back up blocks in appropriate position relative to the space between the plate members. This requires a user to remove the release liner, and then adhere each edge region to a plate member, which can be challenging for scenarios where access to one or both of the plate members is limited.

Accordingly, there is a need for improvements relating to welded assemblies that include backing members.

### SUMMARY OF THE INVENTION

According to one aspect of this disclosure, a welded assembly is provided and includes a first metal component, a second metal component, and a welded butt joint connecting the first metal component and the second metal component. The welded assembly further includes a backing member positioned adjacent to the welded butt joint, and a retaining bracket. The retaining bracket includes an attachment leg secured to the first metal component, and a support leg holding the backing member and urging the backing member toward the welded butt joint. The support leg has a free distal end.

According to another aspect of this disclosure, a method is provided for forming a welded assembly. The method includes positioning a first metal component and a second metal component in abutting relationship with each other. An attachment leg of a retaining bracket is secured to the first metal component, and the retaining bracket further includes a support leg holding a backing member and having a free distal end. The method further includes urging the backing member toward the first metal component and the second metal component, and performing a welding operation to form a welded butt joint connecting the first metal component and the second metal component.

According to yet another aspect of this disclosure, a bracket is provided for use in forming a welded assembly of a first metal component and a second metal component. The bracket includes an attachment leg and a support leg. The attachment leg is configured to be secured to the first metal component, and the support leg is configured to hold a backing member and to urge the backing member toward the first metal component and the second metal component in the welded assembly.

### BRIEF DESCRIPTION OF THE DRAWINGS

FIG. 1 is a cross section view showing a welded assembly that includes a first metal component, a second metal component, a retaining bracket, and a backing member. The first and second metal components are connected together by a welded butt joint.

FIG. 2 is an isometric view showing the retaining bracket and backing member of FIG. 1.

FIG. 3 is a cross section view showing the retaining bracket and backing member of FIG. 1.

FIG. 4 is a cross section view showing the first and second metal components of FIG. 1 positioned in abutting relationship, and with the retaining bracket secured to the first metal component and the backing member held by the retaining bracket.

FIGS. 5A and 5B are cross section views showing a support leg of the retaining bracket being deflected so as to bring the first and second metal components into alignment.

### DETAILED DESCRIPTION

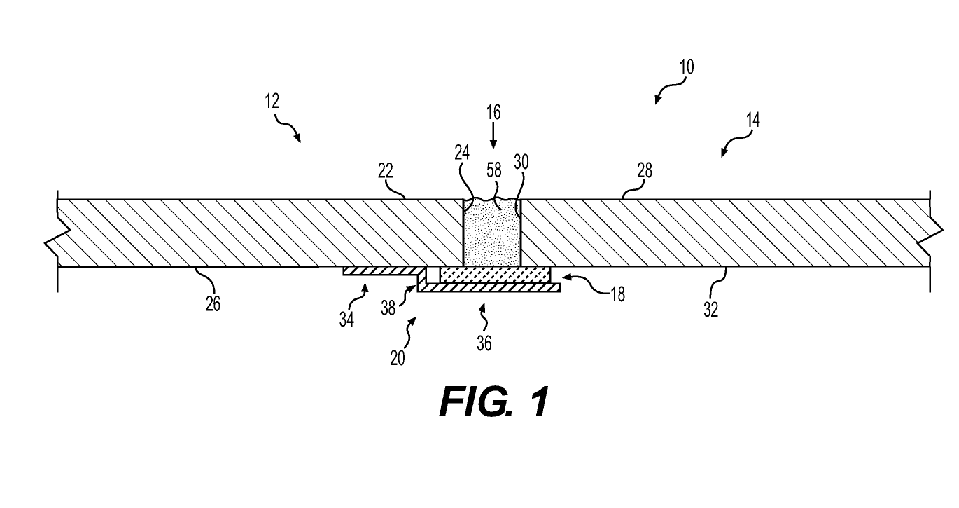

Referring to the figures and beginning with FIG. 1, a welded assembly 10 includes a first metal component 12 and a second metal component 14, which are connected together by a welded butt joint 16. The welded assembly 10 also includes a backing member 18 positioned on one side of the welded butt joint 16, and a retaining bracket 20. The retaining bracket 20 is secured to the first metal component 12 and holds the backing member 18 adjacent to the welded butt joint 16. The retaining bracket 20 urges the backing member 18 toward the first and second metal components 12, 14, and toward the welded butt joint 16.

The first metal component 12 includes a top surface 22, an end surface 24, and a bottom surface 26. The end surface 24 extends between the top surface 22 and the bottom surface 26. Similarly, the second metal component 14 includes a top surface 28, an end surface 30, and a bottom surface 32. The end surface 30 extends between the top surface 28 and the bottom surface 32. In some embodiments, the first and second metal components 12, 14 may be sheet-metal components.

The top surface 22 of the first metal component 12 may extend generally parallel with the bottom surface 26. Similarly, the top surface 28 of the second metal component 14 may extend generally parallel with the bottom surface 32. In the welded assembly 10, the top surfaces 22, 28 may be generally co-planar. Also in the welded assembly 10, the bottom surfaces 26, 32 may be generally co-planar.

In the embodiment shown, each of the end surfaces 24, 30 includes a straight-line profile that extends substantially perpendicular between the respective top surfaces 22, 28 and bottom surfaces 26, 32. In other embodiments, the end surfaces 24, 30 can have other profile shapes, such as, for example, those that would provide a u-, v-, double u-, or double v-type butt joint.

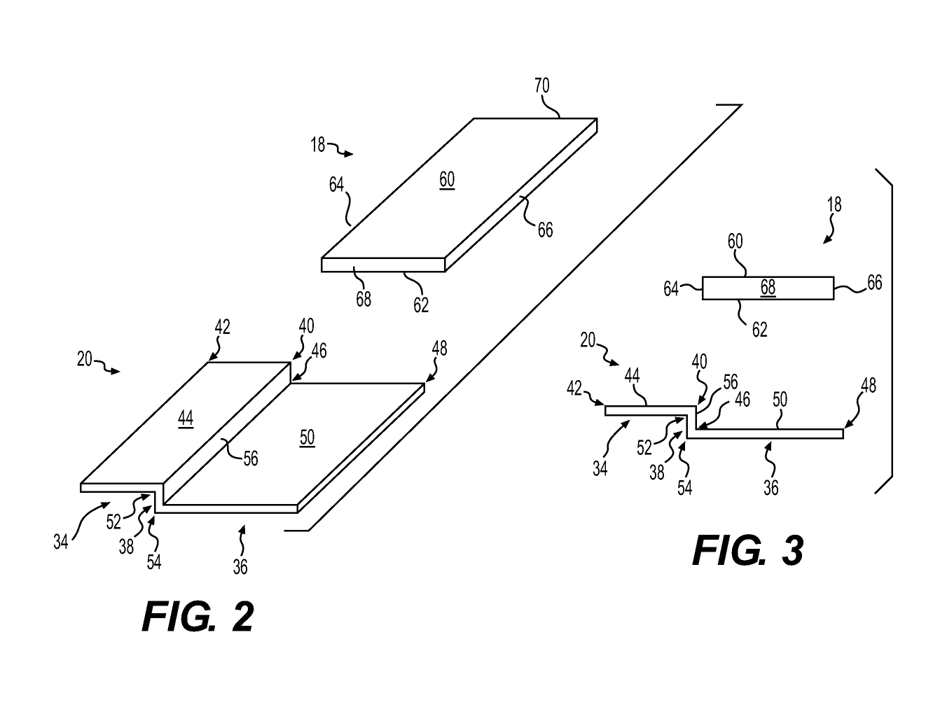

Referring next to FIGS. 2 and 3, the retaining bracket 20 is a three-legged bracket that includes an attachment leg 34, a support leg 36, and a connecting leg 38, all of which are generally rigid. The connecting leg 38 is between the attachment leg 34 and the support leg 36.

In the welded assembly 10, the attachment leg 34 is secured to the first metal component 12 (see FIG. 1). For example, the attachment leg 34 may be welded to the first metal component 12, or may be stuck to the first metal component 12 by an adhesive. As shown, the attachment leg 34 is secured to the bottom surface 26 of the first metal component 12.

The attachment leg 34 extends between a proximal end 40 and a distal end 42. The attachment leg 34 is rigidly joined with the connecting leg 38 at the proximal end 40. The attachment leg 34 includes an attachment surface 44. In the welded assembly 10, the attachment surface 44 is in contacting relationship with the first metal component 12 (see FIG. 1). In particular, the attachment surface 44 is secured to the bottom surface 26 of the first metal component 12 substantially between the proximal end 40 and the distal end 42 of the attachment leg 34.

The attachment leg 34 is secured to the first metal component 12 such that the support leg 36 is positioned to support the backing member 18 adjacent to the space between the first and second metal components 12, 14. Thereby, the backing member 18 is supported adjacent the welded butt joint 16 in the welded assembly 10.

The support leg 36 holds the backing member 18 and urges it toward the welded butt joint 16 in the welded assembly 10. In particular, the backing member 18 is held between the support leg 36 and the first and second metal components 12, 14. The support leg 36 urges the backing member 18 toward the first metal component 12 and the second metal component 14, and in particular toward the bottom surfaces 26, 32 thereof. Thereby, the backing member 18 may be held tightly against the first and second metal components 12, 14.

The support leg 36 extends between a proximal end 46 and a distal end 48. The support leg 36 is rigidly joined with the connecting leg 38 at the proximal end 46. The support leg 36 includes a support surface 50. In the welded assembly 10, the support leg 36 is spaced from and not secured to the second metal component 14 (see FIG. 1). Thereby, the distal end 48 is a free end.

In the welded assembly 10, the support leg 36 is canted with respect to the connecting leg 38 such that the support leg 36 extends somewhat toward the first and second metal components 12, 14. Thereby, the support leg 36 is configured to urge the backing member 18 in the direction toward the first and second metal components 12, 14. Also in the welded assembly 10, the support surface 50 of the support leg 36 is in contacting relationship with the backing member 18.

The attachment surface 44 and the support surface 50 may extend in non-parallel relationship with each other.

The connecting leg 38 extends between a first end 52 and a second end 54, and includes an adjacent surface 56. The connecting leg 38 is joined with the attachment leg 34 at the first end 52, and is joined with the support leg 36 at the second end 54. The adjacent surface 56 is adjacent the attachment surface 44 at the first end 52, and adjacent the support surface 50 at the second end 54.

In the welded assembly 10, the connecting leg 38 extends away from the first and second metal component 12, 14 (see FIG. 1). As shown, the connecting leg 38 may extend substantially perpendicular to the attachment leg 34.

The retaining bracket 20 may be formed of any suitable material. For example, in some embodiments the retaining bracket 20 may be formed of steel.

The backing member 18 is held by the support leg 36 in the welded assembly 10, and serves to support molten weld material 58 that is put into the space between the first and second metal components 12, 14 when the welded butt joint 16 is formed. In particular, the backing member 18 is held by the support leg 36 so as to close the space between the first and second metal components 12, 14. Thereby, molten weld material 58 that is put into the space between the first and second metal components 12, 14 may be prevented from passing the bottom surfaces 26, 32 when the welded butt joint 16 is formed.

Generally, the backing member 18 may be formed of any suitable material. In some embodiments, the backing member 18 may be a ceramic backing member.

The backing member 18 may have a substantially flat cuboid shape, which provides a top surface 60, a bottom surface 62, first and second lateral edge surfaces 64, 66, and first and second end surfaces 68, 70. In the welded assembly 10, the top surface 60 may be in confronting relationship with the bottom surfaces 26, 32 of the first and second metal components 12, 14 (see FIG. 1). Also in the welded assembly 10, the backing member 18 may be in contacting relationship with at least one of the first and second metal components 12, 14. Also in the welded assembly 10, the top surface 60 of the backing member 18 may be generally co-planar with the bottom surfaces 26, 32.

The retaining bracket 20 may be configured and positioned relative to the first and second metal components 12, 14 such that in the welded assembly 10, the backing member 18 is be substantially centered with respect to the welded butt joint 16. Thereby, a generally equal amount of the backing member 18 extends under each of the first and second metal components 12, 14.

The welded assembly 10 may be formed as follows.

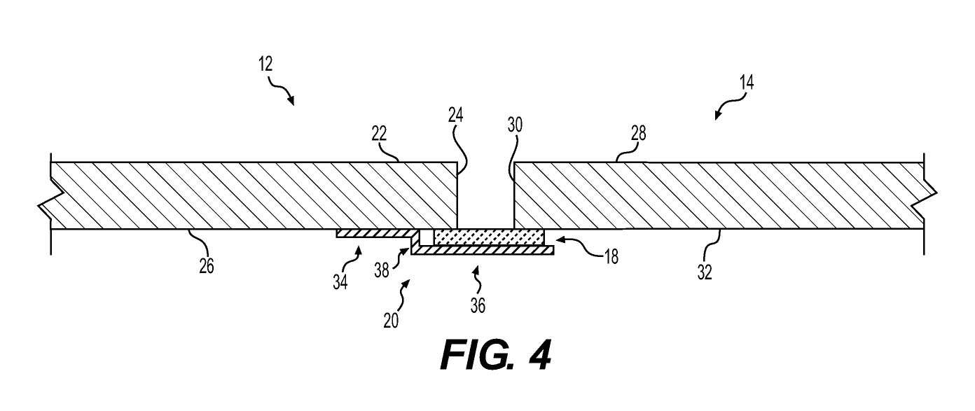

Referring next to FIG. 4, the first and second metal components 12, 14 are positioned in abutting relationship with each other, such that the end surface 24 of the first metal component 12 is in confronting, and somewhat spaced, relationship with the end surface 30 of the second metal component 14.

The retaining bracket 20 may be secured to the first metal component 12 before the first and second metal components 12, 14 are positioned in abutting relationship with each other. For example, the attachment leg 34 of the retaining bracket 20 may already be secured to the bottom surface 26 of the first metal component 12 before the first and second metal components 12, 14 are positioned in abutting relationship. As discussed above, the retaining bracket 20 may be welded to the first metal component 12, or may be stuck to the first metal component 12 by an adhesive. Alternatively, the retaining bracket 20 may be secured to the first metal component 12 after the first and second metal components 12, 14 are positioned in abutting relationship with each other.

The support leg 36 of the retaining bracket 20 holds the backing member 18. The backing member 18 may be positioned on the support leg 36 (in particular on the support surface 50 of the support leg 36) either before or after the first and second metal components 12, 14 are positioned in abutting relationship with each other. Because the distal end 48 of the support leg 36 is a free end, the backing member 18 may easily be positioned on the support leg 36.

The backing member 18 is urged toward the first and second metal components 12, 14. As discussed above, the support leg 36 is somewhat canted relative to the connecting leg 38, such that the support leg 36 extends somewhat toward the first and second metal components 12, 14. The support leg 36 may thereby urge the backing member 18 into contacting relationship with at least one of, or perhaps both of, the first and second metal components 12, 14.

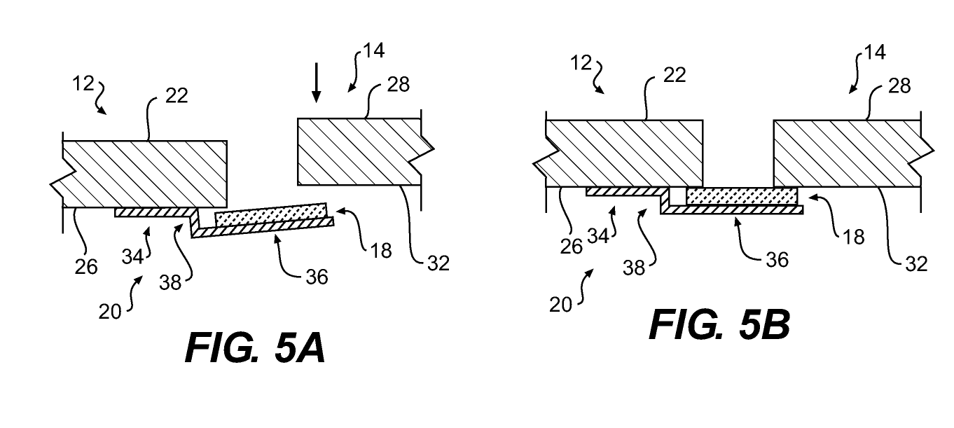

In some instances, and referring next to FIGS. 5A and 5B, it may be necessary to deflect the support leg 36 somewhat relative to the second metal component 14 so as to bring the first and second metal components 12, 14 into proper alignment. For example, the bottom surface 32 of the second metal component 14 and the backing member 18 may be pressed against each other so as to bring the bottom surface 26 of the first metal component 12 into substantial alignment with the bottom surface 32 of the second metal component 14. This may be accomplished, for example, by moving the second metal component 14 while holding the first metal component 12 stationary, so that the bottom surface 32 is pressed against the backing member 18, causing the support leg 36 to deflect away from the second metal component 14 until the bottom surfaces 26, 32 are aligned.

A welding operation is performed to form the welded butt joint 16 connecting the first and second metal components 12, 14 (see FIG. 1). Molten weld material 58 is introduced into the space between the end surfaces 24, 30 of the first and second metal components 12, 14. In particular, the molten weld material 58 is introduced into the space from the side of the top surfaces 22, 28 of the first and second metal components 12, 14. The molten weld material 58 fills this space. And as discussed above, the presence and position of the backing member 18 may prevent the molten weld material 58 from passing the bottom surfaces 26, 32 of the first and second metal components 12, 14.

### INDUSTRIAL APPLICABILITY

According to the foregoing, a welded assembly is provided that includes a backing member supported by a retaining bracket. Forming such a welded assembly may be appropriate or desirable in many scenarios. For example, in the case where a welder can only access one side of a weld joint, the retaining bracket can hold the backing member tightly in place while a welding operation is performed from the accessible side. The backing member may then be left on the inaccessible side of the weld joint, with the retaining bracket continuing to tightly hold the backing member in place.

Furthermore, the retaining bracket is secured to only one of the metal components of the welded assembly. The support leg of the retaining bracket has a free end, and is not secured to a metal component. Thereby, it is not necessary to secure the support leg to a metal component.

Further still, by holding a backing member in place with a retaining bracket, adhesive and tape for holding the backing member in place can be avoided. The performance of adhesive and tape tends to degrade under the heat of a welding operation, and the retaining bracket better holds the backing member.

What is claimed is:

1. A welded assembly, comprising:
a first metal component,
a second metal component,
a welded butt joint connecting the first metal component and the second metal component,
a backing member positioned adjacent to the welded butt joint, and
a retaining bracket having an attachment leg secured to the first metal component, and a support leg holding the backing member and urging the backing member toward the welded butt joint, the support leg having a free distal end.

2. The welded assembly of claim 1, the first metal component having a first surface and the second metal component having a second surface, the first surface and the second surface being generally co-planar, and
the attachment leg of the retaining bracket being secured to the first surface, and the support leg urging the backing member toward the first surface and the second surface.

3. The welded assembly of claim 2, the backing member having a third surface, the third surface being in confronting relationship with the first surface and the second surface.

4. The welded assembly of claim 3, the third surface being generally co-planar with the first surface and the second surface.

5. The welded assembly of claim 1, the backing member being substantially centered with respect to the welded butt joint.

6. The welded assembly of claim 1, the retaining bracket further including a connecting leg between the attachment leg and the support leg, the connecting leg extending away from the first metal component and the second metal component.

7. The welded assembly of claim 6, the support leg extending from the connecting leg toward the second metal component.

8. The welded assembly of claim 1, the attachment leg of the retaining bracket being welded to the first metal component or secured to the first metal component by an adhesive.

9. The welded assembly of claim 1, backing member being a ceramic backing member.

10. The welded assembly of claim 1, the backing member being in contacting relationship with at least one of the first metal component and the second metal component.

11. A method of forming a welded assembly, comprising:
positioning a first metal component and a second metal component in abutting relationship with each other, an attachment leg of a retaining bracket being secured to the first metal component, and the retaining bracket further including a support leg holding a backing member and having a free distal end,
urging the backing member toward the first metal component and the second metal component, and
performing a welding operation to form a welded butt joint connecting the first metal component and the second metal component.

12. The method of claim 11, further comprising:
urging the backing member into contacting relationship with at least one of the first metal component and the second metal component.

13. The method of claim 11, the first metal component including a first surface and the second metal component including a second surface, the method further comprising:
pressing the second surface against the backing member to bring the second surface into substantial alignment with the first surface.

14. The method of claim 11, further comprising:
deflecting the support leg of the retaining bracket away from the second metal component.

15. The method of claim 11, further comprising:
securing the retaining bracket to the first metal component before positioning the first metal component and the second metal component in abutting relationship.

16. The method of claim 15, wherein securing the retaining bracket to the first metal component includes welding the retaining bracket to the first metal component.

17. The method of claim 15, wherein securing the retaining bracket to the first metal component includes sticking the retaining bracket to the first metal component with an adhesive.

18. The method of claim 11, the first metal component including a first surface and the second metal component including a second surface, the method further comprising:
with the backing member, preventing weld material from passing the first surface and the second surface.

19. A bracket for use in forming a welded assembly of a first metal component and a second metal component, the bracket comprising:
an attachment leg configured to be secured to the first metal component, and
a support leg configured to hold a backing member and to urge the backing member toward the first metal component and the second metal component.

20. The bracket of claim 19, the attachment leg having an attachment surface configured to be in contacting relationship with the first metal component, and the support leg having a support surface configured to be in contacting relationship with the backing member, the attachment surface and the support surface being non-parallel with each other.
